(19) United States
(12) Patent Application Publication
(10) Pub. No.: US 2011/0112989 A1
(43) Pub. Date: May 12, 2011

(54) Hybrid Financial Product

(76) Inventor: Jerry Devito, Manhasset, NY (US)

(21) Appl. No.: 12/795,551

(22) Filed: Jun. 7, 2010

Related U.S. Application Data
(63) Continuation of application No. 11/290,621, filed on Nov. 30, 2005, now abandoned.
(60) Provisional application No. 60/731,309, filed on Oct. 28, 2005.

(51) Int. Cl. G06Q 90/00

(52) U.S. Cl. 705/500

(57) ABSTRACT

Disclosed is a hybrid financial security. The security is structured as a collateralized debt obligation which contains senior notes and income notes. Proceeds from the sale of the notes are utilized to purchase the underlying collateral, which is below investment grade debt obligations. The hybrid financial security has improved liquidity, lower volatility, and a shorter maturity term than a traditional collateralized debt obligation.

### CROSS-REFERENCE TO RELATED APPLICATIONS

This application claims priority to U.S. Provisional Application Ser. No. 60/731,309, filed Oct. 25, 2005, the entire contents of which is herein incorporated by reference.

### FIELD OF THE INVENTION

The present invention generally relates to the field of financial securities. More specifically, the present invention provides novel hybrid securities which utilize a collateralized debt obligation (“CDO”) structure. The hybrid securities have significant benefits as compared to traditional hybrid securities, including improved liquidity and lower volatility than traditional CDOs.

### BACKGROUND OF THE INVENTION

Individuals, enterprises, and corporations are continually exposed to the risk of future events beyond their control, which can either positively or negatively impact their financial stability

Certain risk is economic in nature, including fluctuation of commodity prices, currency exchange rates, interest rates, property prices, share prices, inflation rates, and market event based indices. Economic risk can take many forms, from price risk (i.e., the risk of fluctuating prices) to credit risk (i.e., the risk of default). These risks are generally the primary concern of financial markets.

Financial markets measure risk in terms of volatility. Volatility is a statistical measure of the tendency of the value of a market, security, or derivative to rise or fall sharply within a given period of time. If the tendency is for a security to rise or fall very sharply during a relatively short period of time, the security is said to be highly volatile.

From an investment perspective, volatility is considered risk that investors attempt to avoid. In other words, if two assets purport to offer the same return, an investor would prefer to purchase the less volatile (i.e., less risky) asset. Thus, an investor will generally take on increased risk only if the investment could result in potentially higher returns. Typically, an investor who is seeking a higher rate of return on an investment must purchase an instrument with more risk. Therefore, a financial investor should not purchase an asset if a second asset exists with a more favorable risk-return profile (i.e., if for that level of risk an alternative portfolio exists which has a better expected rate of return).

Modern investment portfolio theory utilizes these behavioral characteristics as a fundamental assumption in determining the ideal combination of investment holdings. An investor's total financial holdings are known as a portfolio. In essence, modern portfolio theory holds that a diversified portfolio (i.e., one that is uncorrelated) optimizes the risk-return profile of a portfolio (i.e., an investor receives maximum returns for minimum risk).

Another assumption under the modern portfolio theory is that a typical investor is indifferent with respect to other characteristics of the portfolio, such as the distribution of returns. That is, the theory assumes that an investor is not concerned with the portfolio's skew or payment schedule.

Mathematically, the theory assumes that the portfolio return is the component-weighted return (i.e., the mean) of the constituent assets. Return changes linearly with component weightings, wᵢ and portfolio volatility is a function of the correlation of the component assets. The change in volatility is non-linear as the weighting of the component assets changes.

As a result, the investor considers only the expected return (i.e., the mean return) and the volatility (i.e. the risk) as relevant factors.

Mathematically, the expected return of a portfolio is expressed as:

$$E ( {R}_{p} ) = {\sum }_{i} {w}_{i} E ( {R}_{i} )$$

The variance of such a portfolio will be the sum of the product of every asset pair's weights and covariance, σᵢⱼ. This sum includes the squared weight and variance σᵢᵢ (σᵢ²) for each individual asset. Covariance is often expressed in terms of the correlation in returns between two assets ρᵢⱼ where σᵢⱼ=σᵢσⱼρᵢⱼ

$${σ}_{p}^{2} = {\sum }_{i} {\sum }_{j} {w}_{i} {w}_{j} {σ}_{ij} = {\sum }_{i} {\sum }_{j} {w}_{i} {w}_{j} {σ}_{i} {σ}_{j} {ρ}_{ij}$$

The portfolio volatility is expressed as:

σₚ\sqrt{σₚ²}

For example, consider the return for a two asset portfolio. The portfolio return is:

E(Rₚ)=ω_{A}E(R_{A})+(1−ω_{A})E(R_{B})=ω_{A}E(R_{A})+ω_{B}E(R_{B})

And the portfolio variance is expressed as:

σₚ²=ω_{A}²σ_{A}²+ω_{B}²σ_{B}²+2ω_{A}ω_{B}σ_{AB}

Similarly, for a three asset portfolio, the variance is:

ω_{A}²σ_{A}²+ω_{B}²σ_{B}²+ω_{C}²σ_{C}²+2ω_{A}ω_{B}σ_{AB}+2ω_{A}ω_{C}σ_{AC}+2ω_{B}ω_{C}σ_{BC}

From the above, it can be seen that as the number of assets (n) in the portfolio increases, the calculation becomes very complex (i.e., the number of covariance terms is equal to (n*(n−1)/2).

An investor can reduce portfolio risk simply by holding unrelated instruments. In other words, investors can reduce their exposure to individual asset risk by holding a diversified portfolio of assets. Diversification allows for the same portfolio return with reduced risk. The formulae above shows that if any two assets in the portfolio have a correlation of less than 1 (i.e., they are not perfectly correlated) the portfolio variance (i.e., the volatility) will be less than the weighted average of the individual instruments' volatilities. As a result, investors are constantly searching for improved investment opportunities that provide improved risk-reward profiles.

One type of investor is a credit investor, who purchases credit exposure, such as bonds, credit derivatives, or any other known credit related instruments. The primary risk associated with such credit investments is default risk (i.e., the risk that the holder of the debt will not be able to repay the debt). Credit investors generally utilize traditional diversification techniques to improve the risk-reward profile of credit investments as well as a concept known as subordination. Subordination refers to the practice of creating a tiered debt structure to govern the order in which the debt tiers are paid. For example, senior debt refers to debt that is paid first in time. If there is a default on subordinated debt, holders of senior debt receive payment before the subordinated debt (i.e., the junior debt). Thus, subordinated debt is more volatile than senior debt but offers a greater potential return.

Over time, several financial instruments have been developed to take advantage of principles of both diversification and subordination. One such instrument is known as a collateralized debt obligation (“CDO”).

Collateralized debt obligations are securitized interests in pools of assets (i.e., collateral) which is comprised of loans or debt instruments. If a CDO is comprised only of a pool of loans, it is referred to as a collateralized loan obligation (“CLO”). Similarly, a CDO comprised only of bonds is known as a collateralized bond obligation (“CBO”).

Typically, CDOs offer various tiers of subordinated debt, with each tier called a trance. Each such tranch offers various maturity and credit risk characteristics, and are categorized as senior, mezzanine, and subordinated (i.e., equity) according to the respective amount of volatility. In the event of default or underperformance of the CDO scheduled payments to senior tranches take precedence over those of mezzanine tranches, and scheduled payments to mezzanine tranches take precedence over those to subordinated tranches.

To assist investors in assessing the risks of a particular CDO, individual tranches are rated by recognized ratings agencies such as Moody's and/or Standard & Poors. The ratings agencies attempt to reflect both the credit quality of a CDOs underlying collateral as well as the protection a given tranch is afforded by tranches that are subordinate to it. Typically, senior debit is rated on a scale of A to AAA and mezzanine tranches are rated on a scale of B to BBB.

Each CDO has a sponsor to create and manage a special purpose vehicle (e.g., a limited liability corporation) to hold collateral and issue securities. Examples of sponsors include banks and other financial institutions or investment managers. To compensate the sponsor for managing the assets associated with the CDO, the special purpose vehicle deducts service charges from the cash flows to investors. In addition, the sponsoring organization may retain one or more subordinate tranches of the CDO.

CDOs take several forms. For example, CDOs can have various characteristics, including being static or managed. In a static CDO, collateral is fixed throughout the life of the CDO, allowing investors to assess the various tranches of the CDO with full knowledge of what the collateral will be. One disadvantage to static CDOs is that credit risk may be high. A managed CDO, in contrast, involves a portfolio manager to actively manage the collateral of the CDO. As a result, the life of a managed deal can be divided into three phases: Ramp-up, reinvestment, and maturity.

In the ramp-up phase, which typically lasts about a year, the portfolio manager initially invests the proceeds from sales of the CDO's securities. During the reinvestment period (also known as the revolver period) which typically lasts about five years, the manager actively manages the CDO's collateral by reinvesting cash flows and buying and selling assets. Finally, at the maturity date, the collateral matures or is sold and investors are paid accordingly. One disadvantage to a managed CDO is that investors do not know what specific assets the CDO will invest in. Instead, investors know the identity of the portfolio manger and the investment guidelines of the specific CDO. Accordingly, investors in managed CDOs face both credit risk and the risk of poor management.

CDOs can be structured as either cash flow or market value deals. In a cash flow deal, cash flow is used to pay principal and interest to investors. If the cash flow is insufficient to pay all of the interest or capital, principal and interest is paid to tranches in accordance with seniority. In short, all immediate obligations to a senior tranch are fulfilled before any payments are issued to junior tranches. In a market value deal, principal and interest payments to investors come from both collateral cash flow and sale of collateral. However, payments to tranches are related to the overall market value of the CDO. In other words, if the market value of the collateral drops below a predetermined level, no payments are made to the equity tranch. Further drops in a CDO's market value affect other tranches, from the junior tranches up through the senior tranches. Thus, market value CDOs are more flexible than cash flow CDOs because a portfolio manager need not match the cash flows of collateral to those of the various tranches.

A CDO can also be a balance sheet CDO or an arbitrage CDO. In a balance sheet CDO the sponsor is a bank or other institution that holds loans or debt that it wants to remove from its balance sheet. The bank or other institution collateralizes this outstanding debt into a CDO as described above. Arbitrage deals are motivated by the opportunity to add value by repackaging collateral into tranches.

Much of the “arbitrage” in a CDO arises from a persistent market imperfection related to the somewhat arbitrary distinction between investment grade and below investment grade debt. Many institutional investors face limits on their ability to hold below investment grade debt. These limits are influenced by factors such as regulations, capital requirements, and investment restrictions imposed by management. Insurance companies, pension plans, ⁻banks and mutual funds all face some limitations. As a result, below investment grade debt often trades at spreads to investment grade debt that are wider than might be explained purely by credit considerations. A CDO allows a portfolio of below investment grade debt to be repackaged into tranches, certain of which receive investment grade ratings. Because CDOs are designed to transfer credit risk, the structure of a CDO is more relevant for collateral comprised partially or entirely of marginal obligations (rather than investment grade obligations).

Another type of CDO is a synthetic CDO, which utilizes high quality collateral having little or no default risk. A synthetic CDO exposes investors to credit risk by adding credit default swaps (“CDSs”) to the collateral. As with other types of CDOs synthetic CDOs can be static, managed, balance sheet, or arbitrage deals.

Typically, the biggest advantage to synthetic CDOs often is that they don't have to be fully funded. For example, a traditional CDO must raise sufficient capital to invest in a particular security. In contrast, a synthetic CDO can be supported merely by collateral having little or no credit risk.

Despite the numerous advantages of CDOs, there are significant drawbacks associated with them. For instance, CDOs are typically not liquid financial instruments. That is, investors of CDOs must hold the CDO until the maturity date because CDOs are typically not readily convertible into cash. Indeed, many CDOs lack any sort of conversion feature whatsoever. As a result, an investor cannot easily sell a share in a CDO or otherwise convert it into cash. A further disadvantage to typical CDOs is that their volatility is significant. As a result, many conservative investors do not purchase CDOs for fear of large drops in market value. Further, accurately rating CDOs is difficult because of their custom construction, and ratings for individual tranches can be misleading.

Because current traditional CDO structures suffer from the aforementioned and other deficiencies, there is a clear need in the art for a financial instrument that capitalizes on the advantages of a traditional CDO structure while avoiding several of the associated disadvantages. The present invention overcomes the various deficiencies associated with traditional collateralized debt obligations by creating a novel CDO structure that offers improved liquidity, decreased volatility, and more accurate credit agency ratings.

### SUMMARY OF THE INVENTION

Disclosed is a novel financial security. In general, the security comprises senior notes and income notes. The senior notes are rated by an agency such as Moody's or Standard & Poors. The income notes are in some part redeemable for cash. Traditional CDO equity tranches are not redeemable and are thus very illiquid. The redeemable feature of the income notes (i.e., the equity tranche) in accordance with the present invention provides for drastically increased liquidity.

Generally, proceeds from the sale of the notes are utilized to purchase underlying collateral, which is principally comprised of floating rate bank loans and secured bonds. However, any revenue generating collateral can be utilized in accordance with the present invention. Typically, collateral purchased is constrained by prerequisites to ensure that the senior notes can be rated investment grade by the ratings agencies. By way of a non-limiting example, the following table lists several factors and the corresponding requisites for eligible collateral which is utilized in accordance with the present invention.

TABLE ONE
Collateral Eligibility Criteria

| | |
|---|---|
| Collateral Composition | Minimum of 90% bank loans and |
| | senior secured notes. |
| | Maximum of 10% fixed rate high |
| | yield bonds. |
| Diversity Score | Initial expected minimum of 30, |
| | subject to matrix vs. Weighted |
| | Average Moody's Rating Factor |
| | and Minimum Weighted Average |
| | Spread Test. |
| Weighted Average Moody's | Initial expected maximum of 2,220, |
| Rating Factor | subject to matrix vs. Minimum |
| | Weighted Average Spread and |
| | Diversity Score. |
| Caa“Limit” | Maximum of 7.5%. |
| Issuer Concentrations | Maximum of 2% per obligor, provided |
| | that up to five obligors may |
| | constitute 2.5%. |
| Industry Concentrations | Maximum 10% per S&P industry |
| | classification. |
| Synthetic Securities | Maximum of 10%. |
| Non-U.S. Issuers | Maximum of 20%. Additional limits |
| | on Non-US obligors. |
| Sovereign Ratings | Obligors must generally be |
| | domiciled in countries rated at |
| | least Aa2/AA. |
| Minimum Weighted Average | Combined Weighted Average Spread |
| Coupon-Spread Test | and Weighted Average Coupon must |
| | exceed minimum threshold based on a |
| | Minimum Weighted Average Spread of |
| | 2.60% and a Minimum Weighted |
| | Average Coupon of 8.00%. The |
| | Minimum Weighted Average Spread is |
| | subject to matrix vs. Weighted |
| | Average Moody's Rating Factor |
| | and Diversity Score. |
| Zero Coupon Securities/Pay- | Maximum of 5%. |
| In-Kind/Deferred Interest | |
| Revolvers/Delayed-Draw | Maximum of 10%. |
| Facilities | |
| DIP Loans | Maximum of 5%. |
| Structured Finance Securities | None. |
| Discretionary Trading Limits | Maximum of 25% per year. |
| Current Pay Obligations | Maximum of 5%. |

Of course, any criteria can be used to construct a collateral portfolio without departing from the spirit of the invention.

The resulting financial security is structured as a collateralized debt obligation (CDO). Advantageously, the initial leverage, which is a simple ratio of the value of senior notes to the value of income notes, is significantly lower than that of traditional CDOs. Any traditional CDO structure can be utilized in accordance with the present invention. For example, the financial security can be structured as a cash flow CDO, a market value CDO, a balance sheet CDO, or an arbitrage CDO.

The financial instrument of the present invention utilizes a market value coverage test to determine principal and interest payments of the notes. Traditional CDOs do not utilize mark to market coverage tests because the high leverage of traditional CDOs render such a test impractical. The market value coverage ratio provides a means to measure equity Net Asset Value (NAV) for redemption purposes and ensures that there is no adverse selection if assets are sold to fund a partial redemption.

Further, the collateral purchased from the proceeds of the notes is managed by a collateral manager. Collateral managers, which are well known in the art, buy and sell additional debt obligations and otherwise invest any revenues generated by the collateral. Of course, the collateral manager also applies the revenues generated by the collateral to principal and interest payments due to investors.

The financial security of the present invention also has a shorter maturity date than a traditional CDO. Traditional CDOs offer maturity dates of approximately twelve years. The preferred embodiment of the financial security of the present invention utilizes a maturity date of seven years, which improves the liquidity of the security.

To implement the current invention, a collateral manager first constructs the senior notes and income notes in a well known fashion. For example, the collateral manager sets principal payment amounts and interest rates for each tranche. Next, the collateral manager offers the tranches for sale to investors. Proceeds from the sale of the tranches are utilized to purchase the underlying collateral which will generate gains and losses. Any revenue generated by the collateral in excess of the asset coverage ratio first covers interest and principal payments of the senior notes. Any residual revenues are distributed to the income note investors. As a result, it is possible that an income note holder will never receive a payment. Conversely, it is possible that the residual revenues are greater than the interest and principal payments due to the senior note holders (i.e., income note holders can receive more revenues than senior note holders). This offers a potentially higher rate of return to an income note holder. However, since senior note holders are paid first, this tranch carries a lower volatility. Advantageously, the resulting financial security offers more liquidity, lower volatility, and a shorter maturity date than a traditional CDO.

Accordingly, an object of the present invention is to provide a novel hybrid financial security for sale to investors.

Another object of the present invention is to create a financial security with a CDO structure.

Still another object of the present invention is the creation a hybrid financial security with improved liquidity characteristics.

Yet another object of the present invention is the creation a hybrid financial security with improved volatility characteristics.

Another object of the present invention is the creation a hybrid financial security with a shorter maturity date.

It is another object of the present invention to create a hybrid financial security with improved leverage characteristics.

Still a further object of the present invention is to create a hybrid financial security that utilizes a market value asset coverage test.

Yet a further object of the invention is the creation of a hybrid financial security that utilizes a cash flow CDO structure.

### BRIEF DESCRIPTION OF THE DRAWINGS

A further understanding of the present invention can be obtained by reference to a preferred embodiment set forth in the illustrations of the accompanying drawings. Although the illustrated embodiment is merely exemplary of systems for carrying out the present invention, both the organization and method of operation of the invention, in general, together with further objectives and advantages thereof, may be more easily understood by reference to the drawings and the following description. The drawings are not intended to limit the scope of this invention, which is set forth with particularity in the claims as appended or as subsequently amended, but merely to clarify and exemplify the invention.

FIG. 1 shows an example of a term sheet outlining several components of the hybrid financial security in accordance with the preferred embodiment of the present invention.

FIG. 2 is a flow chart of a method of utilizing the hybrid financial security of the preferred embodiment of the present invention to provide income to an investor.

### DETAILED DESCRIPTION OF THE PREFERRED EMBODIMENT

A detailed illustrative embodiment of the present invention is disclosed herein. However, techniques, systems and operating structures in accordance with the present invention may be embodied in a wide variety of forms and modes, some of which may be quite different form those in the disclosed embodiment. Consequently, the specific structural and functional details disclosed herein are merely representative, yet in that regard, they are deemed to afford the best embodiment for purposes of disclosure and to provide a basis for the claims herein which define the scope of the present invention.

Moreover, well known methods, procedures, and substances for both carrying out the objectives of the present invention and illustrating the preferred embodiment are incorporated herein but have not been described in detail as not to unnecessarily obscure aspects of the present invention.

None of the terms used herein, including “security,” “hybrid,” “derivative,” “instrument,” and “financial instrument” are meant to limit the application of the invention. The terms are used interchangeably for convenience and are not intended to limit the scope of the invention. Similarly, the use of the term “investor,” “shareholder,” or “holder” is not meant to limit the scope of the invention to one type of individual, as any entity or individual can utilize the present invention. The following presents a detailed description of a preferred embodiment of the present invention.

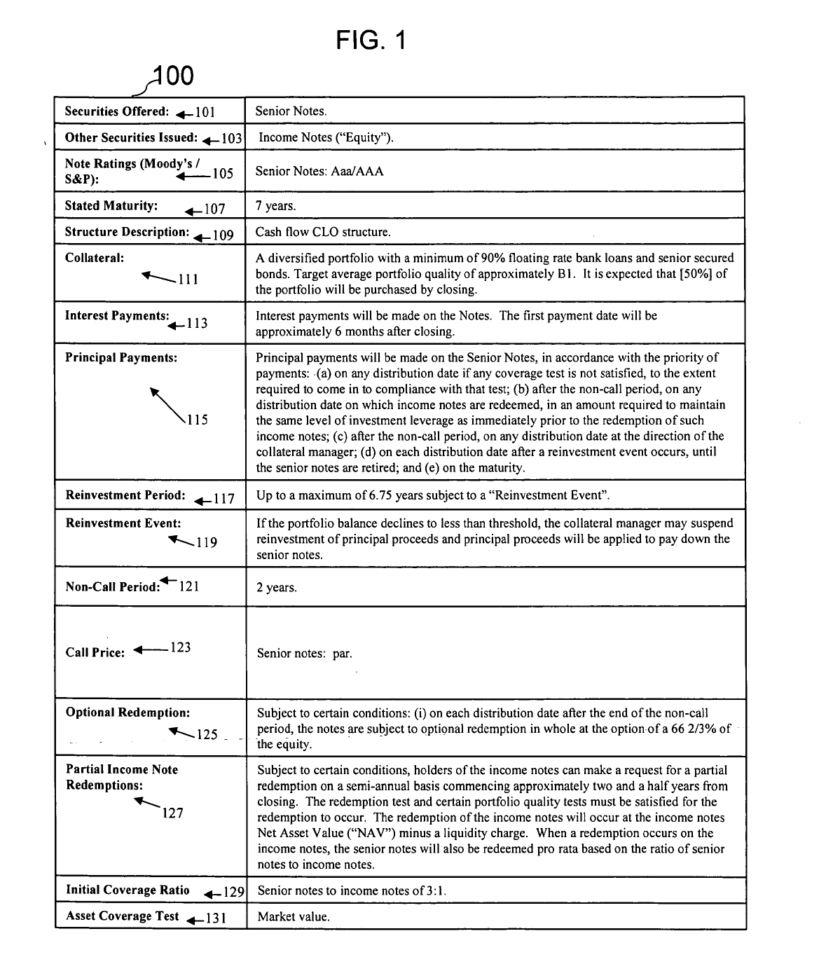

Referring now to FIG. 1, depicted are the component parts of hybrid financial security 100 in accordance with the preferred embodiment of the present invention. The initial components of hybrid security 100 are senior notes 101 and income notes 103. Senior notes are preferably non-recourse debt obligations of the issuer and income notes 103 are preferably non-recourse debt obligations of the underlying fund, although other well known structures can be utilized in accordance with the present invention. Income notes 103 are subordinated in right of senior notes 101 and to fees and expenses. Further, as is well known in the art, senior notes 101 offer principal payments and interest payments to senior note holders. Other well known features of securities, such as conversion options, can be added to senior notes 101 without departing from the spirit of the invention. As shown in FIG. 1, senior notes 101 of the preferred embodiment have a stated maturity 107 of seven years. Advantageously, this is a shorter maturity than a traditional CDO, offering potential investors greater liquidity due to the shorter holding period. Further, senior notes 101 are rated 105 by an agency such as Moody's or Standard & Poors, although any ratings agency can be utilized in accordance with the present invention. To attract investors, it is preferred that senior notes 101 are rated as investment grade. In the example of FIG. 1, ratings 105 comprise a range of AAA to Aaa.

In the preferred embodiment, senior notes 101 are redeemable 125 at the option of the note holder. A note holder can redeem senior notes 101 on any distribution date after non-call period 121 at the direction of a predetermined percentage of a holder of income note holders 103. Further, in the preferred embodiment depicted in FIG. 1, the percentage required for redemption is two-thirds. The distribution date can be any date on which principal payments 115 and interest payments 113 are disbursed as discussed in greater detail below.

As is well known in the art, non-call period 121 is the time from issuance of senior notes 101 to a predetermined time afterward in which note holders can not resell or redeem 125 their notes (i.e., a note holder only receives payments of interest and principal for a predetermined period of time). This provides stability for hybrid financial security 100 because it ensures that the security will be properly funded for a predetermined period of time. In the preferred embodiment, non-call period 121 is two years.

Further, senior notes 101 can be constructed to be redeemed 125 in any other manner currently known in the art. For example, senior notes 101 can be constructed so that they are redeemed 125 upon a specific event such as a federally mandated change in the tax statutes. These event triggers help insulate an investor from any potentially negative event risk. Conversely, senior notes 101 can be constructed such that they can not be redeemed 125 if a specific event occurs. Of course, various other redemption mechanisms can be incorporated into senior notes 101 in accordance with the present invention.

Senior notes 101 are redeemed 125 at call price 123. In the preferred embodiment shown in FIG. 1, call price 123 is par value (i.e., face value of senior notes 101).

Income notes 103 represent the equity tranch of hybrid financial security 100. Income notes 103 can contain any features and properties currently known in the art. In the preferred embodiment, income notes 103 are redeemable 127 in part as shown below. The first partial redemption date can be set at ant time. In the preferred embodiment, the date is six months after the end of non-call period 121.

To invoke a partial redemption 127 in accordance with the preferred embodiment of the present invention, equity investors can request redemption of shares on a semi-annual basis. A maximum percentage of outstanding equity can be redeemed on each redemption date (i.e., every six months). In the preferred embodiment, the maximum percentage is 15%. To limit the number of partial redemptions 127, conditions can be imposed to restrict partial redemptions. For example, a limiting clause can require that partial redemptions 127 must be requested at least 90 days prior to a redemption date. Of course, any other restrictions can be utilized to limit partial redemption 127.

On the redemption date, senior notes 101 are redeemed first at call price 123 plus accrued interest. Income notes 103 are partially redeemed 127 at the Net Asset Value (“NAV”). The NAV is equal to:

$$\frac{( \begin{matrix}Market value of collateral 111 - \\ principal balance of senior notes 101\end{matrix} )}{Outstanding income notes 103}$$

In addition, it is contemplated that charges can be applied against the NAV. For instance, to compensate for the loss of income notes 103, a liquidity charge can be imposed. To maintain leverage ratio 129, senior notes 101 are redeemed on a pro-rata basis. The only effect on senior notes 101 is a partial prepayment of principal 115.

After partial redemption 127, income notes 103 holders receive the NAV of the equity at the time of redemption minus any applicable charges. As a result, income note 103 holders that partially redeem 127 bear the market risk of declines in collateral 111 as it is marked-to-market. Accordingly, partial redemption 127 de-levers the capital structure on a pro-rata basis at par for senior notes 101 and at NAV for income notes 103. In the preferred embodiment, in order to initiate partial redemption 127, certain collateral quality tests must be maintained. As depicted in FIG. 1, in the preferred embodiment, this collateral quality test is asset coverage test 131, a market value test described in greater detail below.

The ratio of the value of issued senior notes 101 to issued income notes 103 forms initial leverage ratio 129. In the preferred embodiment depicted in FIG. 1, initial leverage ratio 129 is 3:1. Other ratios that serve to maintain adequate levels of volatility may also be used in accordance with alternate embodiments of the present invention.

Senior notes 101 and income notes are secured by collateral 111. In accordance with the preferred embodiment, collateral 111 is purchased by the proceeds generated by the sale of senior notes 101 and income notes 103. Collateral 111 can be any financial instrument, tangible good, property, or service. In the preferred embodiment, collateral 111 is a portfolio that comprises leveraged loans and high yield bonds of below investment grade quality. In addition, collateral 111 can comprise structured derivative instruments, synthetic credit derivative instruments and other credit derivative instruments that reference leveraged loans. As depicted in FIG. 1, in the preferred embodiment of the present invention at least 90% of collateral 111 comprises below investment grade quality credit financial debt obligations. Of course, it is contemplated that other portfolio combinations can be used in accordance with the present invention. As collateral 111 generates additional revenue, this revenue can be used either to make principal payments 115 and interest payments 113 or to purchase additional collateral 111.

The purchasing of additional collateral is known as reinvestment. The preferred embodiment of the present invention contains reinvestment period 117, although alternative embodiments of the present invention may not contain such a feature. In the preferred embodiment, reinvestment period 117 is a period of time during which a collateral manager can utilize revenue generated by collateral 111 to purchase additional collateral 111. In the preferred embodiment, this period is defined as 6.75 years, although it should be appreciated by one of ordinary skill in the art that the amount of time can vary.

The preferred embodiment of the present invention also comprises reinvestment event 119. In short, if the value of collateral 111 drops below a threshold amount due to redemption or defaults, the collateral manager can elect to stop reinvesting in additional collateral 111 and begin to make payments on senior notes 101. In addition, the collateral manager can elect to stop reinvesting if the value of collateral 111 has dropped to a point where it is impractical to continue to maintain portfolio diversity.

Interest payments 113 are paid from the proceeds of collateral 111. Interest payments 113 are first paid to holders of senior notes 101 on a predetermined schedule. In the preferred embodiment, interest payments 113 of senior notes 101 occur quarterly. As is known in the art, the amount of interest payment 113 is determined by the interest rate contained in senior notes 101. Any interest rate can be utilized in accordance with the present invention. In the preferred embodiment depicted in FIG. 1, the interest rate for senior notes 101 is LIBOR plus 0.3%.

Income notes 103 do not contain a stated interest rate. Instead, any revenue generated in excess of interest payments 113 to senior notes 101 is paid to income notes 103 as long as the value of collateral 111 sufficiently secures senior notes 101 and income notes 103.

Asset coverage test 131 is utilized to determine if the value of collateral 111 secures senior notes 101 and income notes 103. In the preferred embodiment of the present invention, asset coverage test 131 is a market value test. The collateral manager uses customary third-party pricing services used in the leveraged loan market (e.g., Loan Pricing Corporation, LoanX) and approved by the rating agencies to determine the market value of collateral 111. A market value test has significant benefits when it is utilized in accordance with the present invention. Due to the significant amount of leverage in a traditional CLO structure, mark-to-market coverage tests are impractical. Because the initial leverage of a traditional CDO is very high, a small market value decrease in the underlying collateral would cause the asset coverage test to fail, forcing the collateral manager to take appropriate measures to bring the coverage ratio into compliance.

In contrast, the preferred embodiment of the present invention has only one class of AAA/Aaa senior notes, which results in a very high initial market value coverage ratio. Having substantial value coverage allows the present invention to reduce the amount of volatility. In addition, utilizing a market value test provides a means to measure the NAV of income notes 103 for redemption purposes. It also ensures that there is no adverse selection if assets are sold to fund partial redemption 127. That is, according to the preferred embodiment of the present invention, decreased volatility and increased liquidity can be obtained.

Principal payments 115 of senior notes 101 can occur in any manner as is well known in the art. In the preferred embodiment, principal payments 115 are disbursed in accordance with the priority of payments in the following manner: (a) on any distribution date if asset coverage test 131 is not satisfied, to the extent required to come into compliance with asset coverage test 131; (b) after non-call period 121, on any distribution date on which income notes 104 are redeemed 127, in any amount required to maintain initial leverage ratio 129 as immediately prior to partial redemption 127 of income notes 103; (c) after non-call period 121, on any distribution date at the direction of the collateral manager; (d) on each distribution date after reinvestment event 119 occurs, until senior notes 101 are retired; and (e) on stated maturity 107.

To ensure that principal payments 115 of senior notes 101 are paid in accordance with maturity, several policies can be implemented. In the preferred embodiment the following procedures are utilized to ensure principal payment 115 of senior notes 101: (a) starting 3-months prior to maturity date 107, the manager stops reinvesting and all principal proceeds are retained to pay down senior notes 101; (b) the collateral manager is required to use its commercially reasonable efforts to sell collateral 111 as necessary such that available proceeds will be available to pay down senior notes 101; (c) if a threshold amount is met by the second month prior to maturity date 107, the collateral manager continues to sell collateral 111 as needed to redeem senior notes 101 in full; (d) if sufficient proceeds to redeem senior notes 101 in full are not available one month prior to maturity date 107, collateral 111 can be liquidated; and (e) if the threshold amount is not met by the second month prior to maturity date 107, collateral 111 can be liquidated. Of course, any other well known mechanism for ensuring that principal payments are made at maturity date 107 can be utilized without departing from the spirit of the present invention. For example, hybrid financial security 100 can contain a proviso for an increased asset coverage test 131, which provides an incentive for the collateral manager to begin paying down senior notes 101 to increase coverage.

The overall structure 109 of hybrid financial security 100 is that of a CDO. In the preferred embodiment, structure 109 is a cash flow CDO. Of course, hybrid financial security can be structured as any other CDO, including a market value CDO, a balance sheet CDO, or an arbitrage CDO.

In the preferred embodiment of the present invention, hybrid financial security 100 is actively managed by a collateral manager. The benefits of a collateral manager are well known in the art. As such, a further description is not warranted. Of course, other well known management techniques can be utilized in accordance with the present invention without departing from the scope of the invention.

An overall comparison of the various features of a hybrid financial security 100 in accordance with the present invention to a traditional CDO is summarized in the table below.

TABLE 2
Comparison of Securities

| | PREFERRED EMBODIMENT | |
|---|---|---|
| | OF THE PRESENT | TRADITIONAL |
| TERM | INVENTION | CDO |
| Final Maturity | 7 years | 12+ years |
| Leverage | 3x (25% Equity) | 11x (8.5% Equity) |
| (Debt/Equity) | | |
| Rated Debt | 1-Rated Class | 4 to 5-Rated Classes |
| Classes | | |
| Reinvestment | Up to 6.75 years | 5 to 7 years |
| Period | | |
| Coverage Tests | Market Value OC Test | Par Value OC Test |
| | Cash Interest | Cash Interest |
| | Coverage Test | Coverage Test |
| Eligible | Same as a traditional CLO | — |
| Collateral | | |
| Trading | Same as a traditional CLO | — |
| Restrictions | | |
| Non-Call Period | 2 years | 3 to 5 years |
| Redemption in | Equity vote after | Equity vote after |
| Whole | Non-Call | Non-Call |
| Redemption in | Equity may redeem in part | Usually not allowed |
| Part | after Non-Call Period | |
| | plus six months, subject | |
| | to various tests | |
| Target Equity | ~7%-9% (L + 400 bp) | ~12%-15% |
| Returns | | |
| Failure of OC | Excess interest | Excess interest |
| test | proceeds diverted to | proceeds diverted to |
| | pay down the Senior Notes | pay down the Notes |

The preceding table highlights several novel characteristics of the present invention. The combination of cash flow structure 109 with a market value asset coverage test provides several unique advantages to holders of senior notes 101. Unlike traditional cash CDOs which only mark-to-market defaulted collateral, discount collateral and certain excess CCC rated collateral, the present invention marks all collateral to market. As a result, collateral 111 is immediately impacted by declines in market value due to credit stress in the portfolio. In a traditional CDO the asset coverage test is only adjusted when assets default. Further, a market value test provides a rating agency credit assessment and a market assessment of credit quality.

In addition, a collateral manager receives no credit for par-building (i.e., the collateral manager cannot build asset coverage by buying discount collateral). Therefore, there is no structural incentive to purchase discount or distressed assets. Consequently, the collateral manager has a broader universe of credits to buy from since there is no structural disadvantage to buying assets that are trading at a premium. Most traditional CDO managers avoid premium assets due to the structural penalty for premiums in a cash flow CDO

In addition, the structure of hybrid financial security 100 provides several advantages to holders of income notes 103. The present invention provides investors access to a leveraged loan asset class with a moderately leveraged basis. The present invention provides partial liquidity of investment, less leverage/return volatility than a traditional CDO, and a shorter final maturity 107. The structure 109 is designed as a cash flow deal to avoid the need for forced collateral liquidation common to traditional market value CDO structures.

As a result, the current invention provides a unique security with improved liquidity characteristics, a lower volatility, and a shorter maturity date.

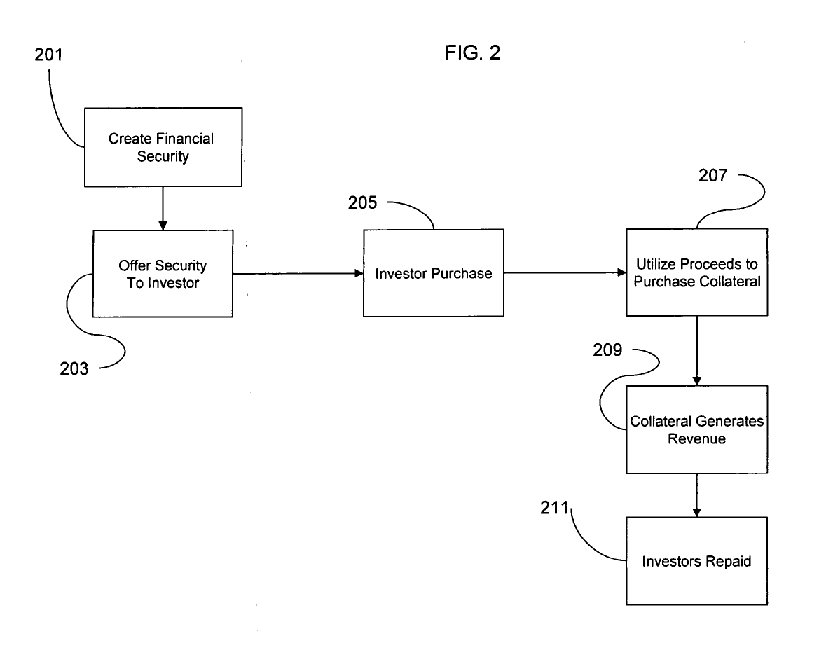

Referring now to FIG. 2, depicted is a method of utilizing the hybrid financial security of the present invention to provide income to an investor. Initially, a hybrid financial security is created with properties corresponding to those previously described 201.

Next, the security is offered for sale to an investor 203. Specifically, senior notes and income notes are offered for sale at any price, however, the ratio of the value of senior notes to the value of income notes is approximately 3:1.

An investor then purchases some combination of senior notes and income notes 205. The proceeds from this purchase are utilized by the collateral manager to purchase underlying collateral. The collateral can be any well known financial instrument, tangible good, property, or service. In the preferred embodiment the collateral is a portfolio of leveraged loans and high yield bonds of below investment grade quality. In addition, the collateral can comprise any financial security, including structured derivative instruments, synthetic credit derivative instruments and other credit derivative instruments that reference leveraged loans. In accordance with the preferred embodiment, at least 90% of the collateral comprises below investment grade quality debt obligations. Of course, it is contemplated that other portfolio combinations can be used in accordance with the present invention.

The collateral generates revenue 209 in accordance with the terms of the particular collateral. For instance, in the case of a portfolio of high yield debt obligations, the collateral generates revenue through interest income and principal repayment.

Finally, investors are compensated for their initial investment 211. For example, interest payments are paid from the proceeds of collateral to holders of senior notes on a predetermined schedule. In the preferred embodiment, interest payments of senior notes occur quarterly. As is well known in the art, the amount of an interest payment is determined by the interest rate contained in the senior notes. Any interest rate can be utilized in accordance with the present invention. In a preferred embodiment, the interest rate for senior notes is LIBOR plus 0.3%.

Income notes do not contain a stated interest rate. Instead, any revenue generated in excess of interest payments to senior notes is paid to income notes as long as collateral is able to sufficiently secure senior notes and income notes as previously discussed.

Principal payments of senior notes can occur in any manner as is well known in the art. As previously discussed, in a preferred embodiment principal payments are made in accordance with a priority of payments. Of course, other repayment mechanisms can be utilized in accordance with the present invention without departing from the spirit of the invention.

What is claimed is:

1. A hybrid financial security comprising:
at least one senior note comprising a principal payment and an interest payment;
at least one redeemable income note comprising an interest payment;
collateral comprising at least 90% lower than investment grade debt obligations;
a market value asset coverage test;
an initial leverage ratio determined by said senior note and said redeemable income note;
wherein said senior note and said redeemable income note generate revenue which is utilized to purchase said collateral; and
wherein said collateral generates revenue which is utilized to pay said principal payment, said senior note interest payment, and said income note interest payment subject to said market value asset coverage test.

2. The hybrid financial security of claim 1, wherein said at least one senior note is rated as investment grade by a ratings agency.

3. The hybrid financial security of claim 1, wherein said lower than investment grade debt obligations comprises at least one selected from the group consisting of floating rate bank loans, senior secured bonds, and combinations of two.

4. The hybrid financial security of claim 1, further comprising a reinvestment event.

5. The hybrid financial security of claim 1, wherein said leverage ratio is about 3:1.

6. The hybrid financial security of claim 1, further comprising a non-call period.

7. The hybrid financial security of claim 6, wherein said non-call period is two years.

8. The hybrid financial security of claim 1, further comprising a stated maturity.

9. The hybrid financial security of claim 8, wherein said stated maturity is seven years.

10. The hybrid financial security of claim 1, wherein said collateral is managed by a collateral manager.

11. A structured investment, comprising a collateralized debt obligation structure in which the portfolio of hybrid securities defined in claim 1 defines the asset class in the collateralized debt obligation.

12. A method of providing revenue to an investor comprising the steps of:
creating a hybrid financial instrument comprising:
at least one senior note comprising a principal payment and an interest payment;
at least one redeemable income note comprising an interest payment;
collateral comprising at least 90% lower than investment grade debt obligations;
a market value asset coverage test;
an initial leverage ratio determined by said senior note and said redeemable income note;
offering said hybrid financial instrument to an investor;
purchasing of said senior note or said income note by an investor;
utilizing proceeds from said purchase of said senior note or said income note to purchase collateral;
generating revenue from said collateral; and
paying said revenue to said investor;
wherein said market value asset coverage test is utilized to determine the manner and amount of revenue paid to said investor.

13. The method of claim 12, wherein said at least one senior note is rated as investment grade by a ratings agency.

14. The method of claim 12, wherein said lower than investment grade debt obligations comprises at least one selected from the group consisting of floating rate bank loans, senior secured bonds, and combinations of two.

15. The method of claim 12, further comprising a reinvestment event.

16. The method of claim 12, wherein said leverage ratio is about 3:1.

17. The method of claim 12, further comprising a non-call period.

18. The method of claim 17, wherein said non-call period is two years.

19. The method of claim 12, further comprising a stated maturity.

20. The method of claim 19, wherein said stated maturity is seven years.

21. The method of claim 12, wherein said collateral is managed by a collateral manager.
